(19) United States
(12) Patent Application Publication
(10) Pub. No.: US 2026/0355877 A1
(43) Pub. Date: Nov. 12, 2026

(54) POSITIONING DEVICE

(71) Applicants: CHANG-YI LIN, Taichung City (TW); CHANG-CHIH LIN, Taichung City (TW)

(72) Inventors: CHANG-YI LIN, Taichung City (TW); CHANG-CHIH LIN, Taichung City (TW)

(21) Appl. No.: 19/202,211

(22) Filed: May 8, 2025

(51) Int. Cl. B23Q 3/06

(52) U.S. Cl. CPC B23Q 3/067

(57) ABSTRACT

A positioning device, including: a base, a clamping assembly and a piston. The base includes a plurality of positioning holes, a first receiving groove, a second receiving groove and a first flow channel, and the first flow channel is communicated with the second receiving groove. The clamping assembly is disposed within the first receiving groove and includes a plurality of clamping blocks, a push block and at least one restoring assembly. The push block is movable to laterally push the plurality of clamping blocks to be engaged within the plurality of positioning holes. The piston is movably disposed within the second receiving groove, and the push block is drivable by the piston to move relative to the plurality of clamping blocks.

### BACKGROUND OF THE INVENTION

### Field of the Invention

The present invention relates to a positioning device.

### Description of the Prior Art

A positioning device is applied in fields such as precision machining, CNC machining, mold manufacturing, and five-axis machining. It allows an object (such as positioning jigs, vises, clamps, workpieces, cutting tools, molds, etc.) to be positioned thereon, enabling accurate repositioning when transferring the object between different positioning devices or reinstalling it on the same positioning device.

In conventional technology, the positioning device typically utilizes a threaded rod to connect a first and a second clamping member. By rotating the threaded rod, the first and second clamping members are moved to clamp first and second insertion pins of an object. Conversely, by rotating the threaded rod in an opposite direction, the first and second clamping members are moved to release the first and second insertion pins of the object.

However, using the threaded rod to adjust the first and second clamping members for clamping and releasing the first and second insertion pins results in slow adjustment speed. When the object to be positioned needs to be frequently replaced, it leads to time inefficiency and reduced productivity. In addition, wear of the threaded rod may affect clamping accuracy, and long-term use may result in loosening, causing instability in clamping force.

The present invention is, therefore, arisen to obviate or at least mitigate the above-mentioned disadvantages.

### SUMMARY OF THE INVENTION

The main object of the present invention is to provide a positioning device that enables stable and rapid positioning and release of an object.

To achieve the above and other objects, the present invention provides a positioning device, including: a base, a clamping assembly and a piston. The base includes a plurality of positioning holes, a first receiving groove, a second receiving groove and a first flow channel, and the first flow channel is communicated with the second receiving groove. The clamping assembly is disposed within the first receiving groove and includes a plurality of clamping blocks, a push block and at least one restoring assembly. The push block is movable to laterally push the plurality of clamping blocks to be engaged within the plurality of positioning holes. Each of the plurality of clamping blocks has a first inclined surface, lateral sides of the push block have a plurality of second inclined surfaces, and each of the plurality of second inclined surfaces is movably abutted against the first inclined surface of one of the plurality of clamping blocks. Each of the at least one restoring assembly includes a connector and at least one first elastic member, the connector is disposed through the plurality of clamping blocks, and the at least one first elastic member is elastically abutted against and between one of the plurality of clamping blocks and the connector. The piston is movably disposed within the second receiving groove, the piston is annularly abutted against an inner periphery wall defining the second receiving groove, and the push block is drivable by the piston to move relative to the plurality of clamping blocks.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram of a preferable embodiment of the present invention;

FIG. 2 is a breakdown drawing of a preferable embodiment of the present invention;

FIG. 3 is a partial enlargement of a preferable embodiment of the present invention;

FIG. 4 is a breakdown drawing of a clamping assembly according to a preferable embodiment of the present invention;

FIG. 5 is a breakdown drawing of a base and a plurality of pushing mechanisms according to a preferable embodiment of the present invention;

FIG. 6 is a breakdown drawing of a preferable embodiment of the present invention and an object to be positioned;

FIGS. 7, 9 and 11 are drawings showing a piston being pushed downward according to a preferable embodiment of the present invention;

FIGS. 8 and 10 are drawings showing the piston being pushed upward according to a preferable embodiment of the present invention;

FIG. 12 is a cross sectional view of a preferable embodiment of the present invention when a plurality of clamping blocks are disengaged from a plurality of recesses;

FIG. 13 is a cross sectional view of a preferable embodiment of the present invention when the plurality of clamping blocks are engaged within the plurality of recesses;

FIG. 14 is a cross sectional view of a preferable embodiment of the present invention when a pushing member is in a first position; and

FIG. 15 is a cross sectional view of a preferable embodiment of the present invention when the pushing member is in a second position.

### DETAILED DESCRIPTION OF THE PREFERRED EMBODIMENTS

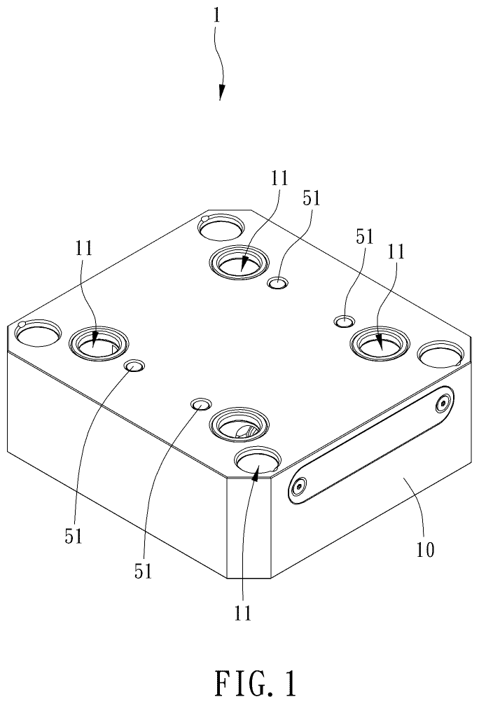

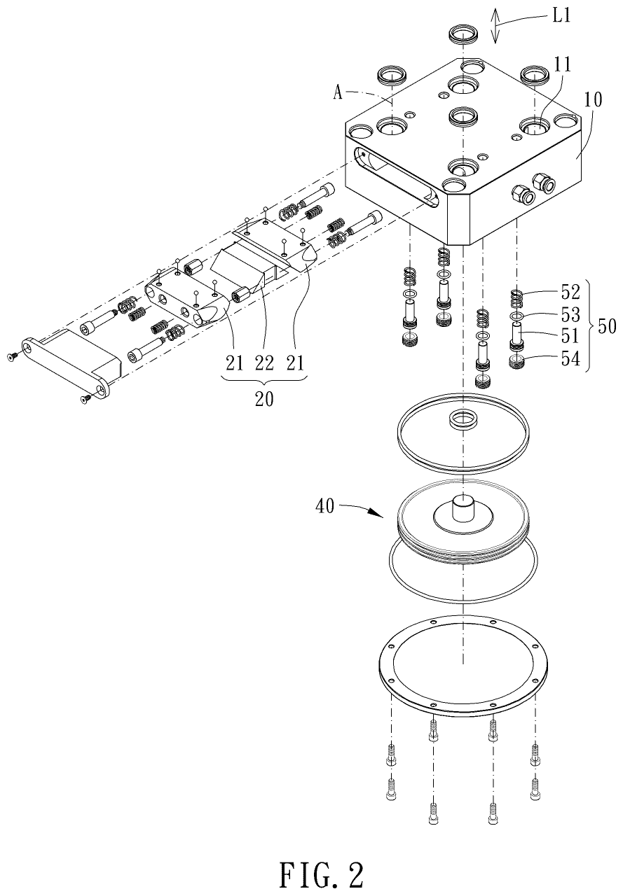

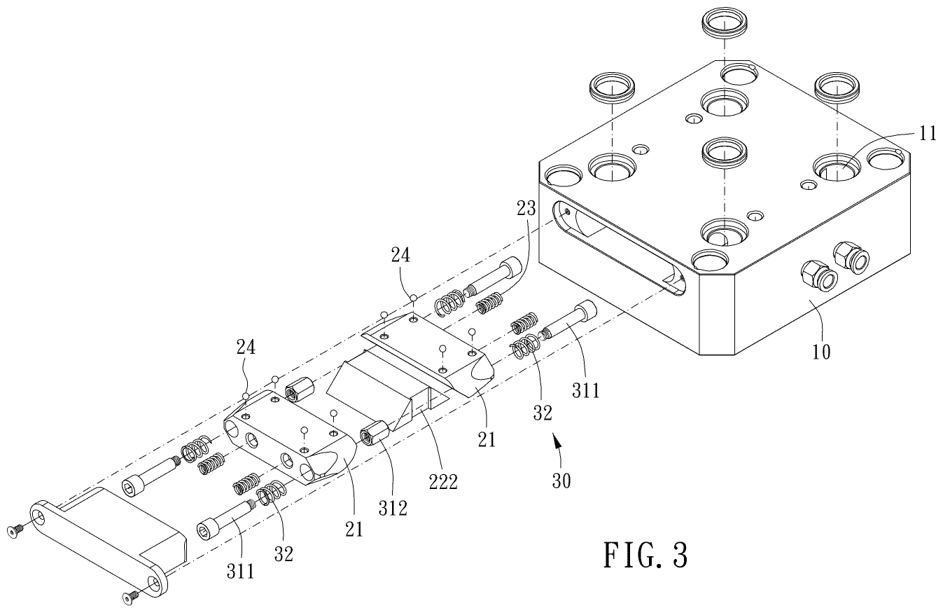

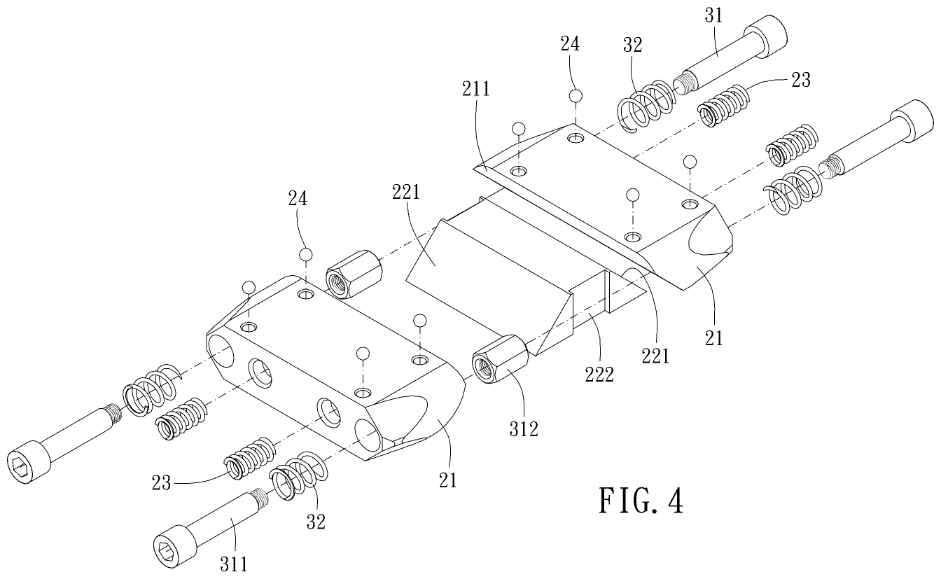

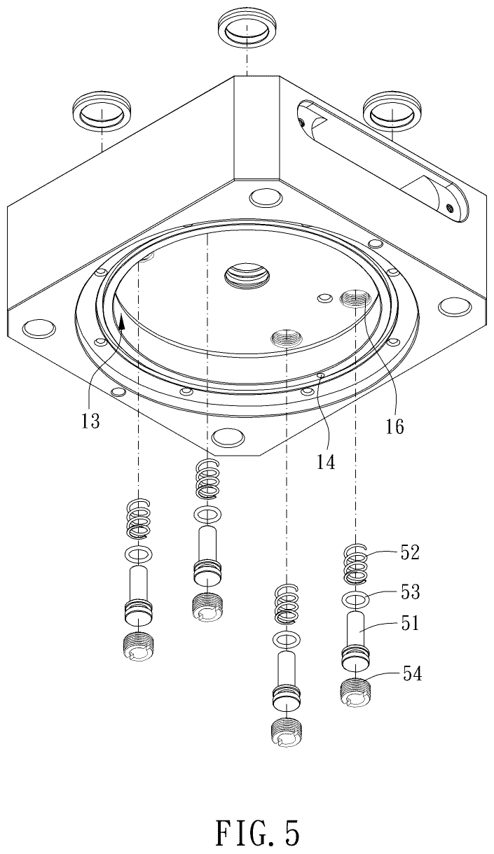

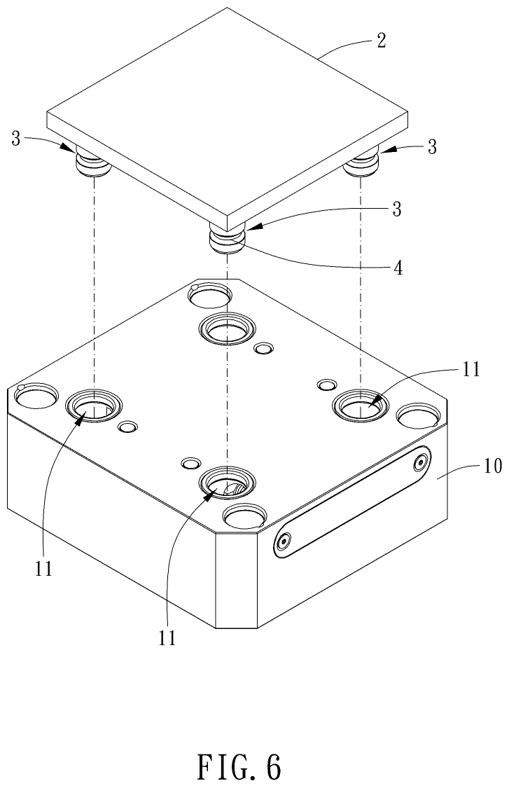

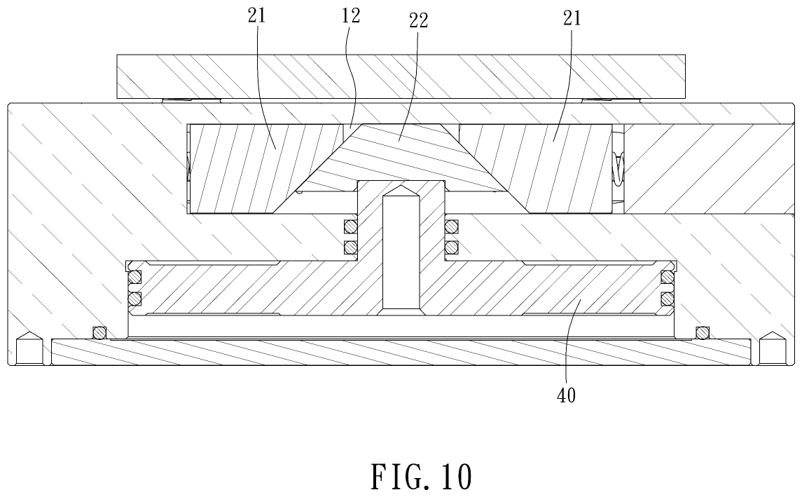

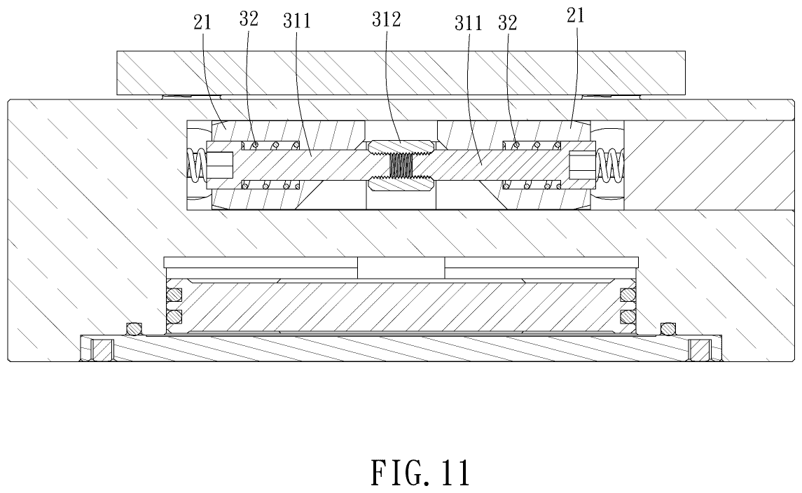

Please refer to FIGS. 1 to 15 for a preferable embodiment of the present invention. A positioning device 1 of the present invention includes a base 10, a clamping assembly 20 and a piston 40.

The base 10 includes a plurality of positioning holes 11, a first receiving groove 12, a second receiving groove 13 and a first flow channel 14. The first flow channel 14 is communicated with the second receiving groove 13. The clamping assembly 20 is disposed within the first receiving groove 12 and includes a plurality of clamping blocks 21, a push block 22 and at least one restoring assembly 30. The push block 22 is movable to laterally push the plurality of clamping blocks 21 to be engaged within the plurality of positioning holes 11. Each of the plurality of clamping blocks 21 has a first inclined surface 211, lateral sides of the push block 22 have a plurality of second inclined surfaces 221, and each of the plurality of second inclined surfaces 221 is movably abutted against the first inclined surface 211 of one of the plurality of clamping blocks 21.

Each of the at least one restoring assembly 30 includes a connector 31 and at least one first elastic member 32, the connector 31 is disposed through the plurality of clamping blocks 21, and each of the at least one first elastic member 32 is elastically abutted against and between one of the plurality of clamping blocks 21 and the connector 31. In this embodiment, each of the at least one first elastic member 32 is abutted against an enlarged head of the connector 31. The piston 40 is movably disposed within the second receiving groove 13 and annularly abutted against an inner periphery wall defining the second receiving groove 13, and the push block 22 is drivable by the piston 40 to move relative to the plurality of clamping blocks 21.

Moreover, each of the positioning holes 11 extends along an axial direction L1, and the axial direction L1 is lateral to a sliding direction S of each of the plurality of clamping blocks 21. The plurality of positioning holes 11 are configured for a plurality of positioning structures 3 (such as insertion columns) of an object to be positioned 2 (such as positioning jigs, vises, clamps, workpieces, cutting tools, molds, etc.) to be detachably received therewithin. The plurality of clamping blocks 21 are configured to be engaged within or disengaged from recesses 4 of the plurality of positioning structures 3, and the axial direction L1 is perpendicular to the sliding direction S, which allows the object to be positioned 2 to be positioned and released rapidly.

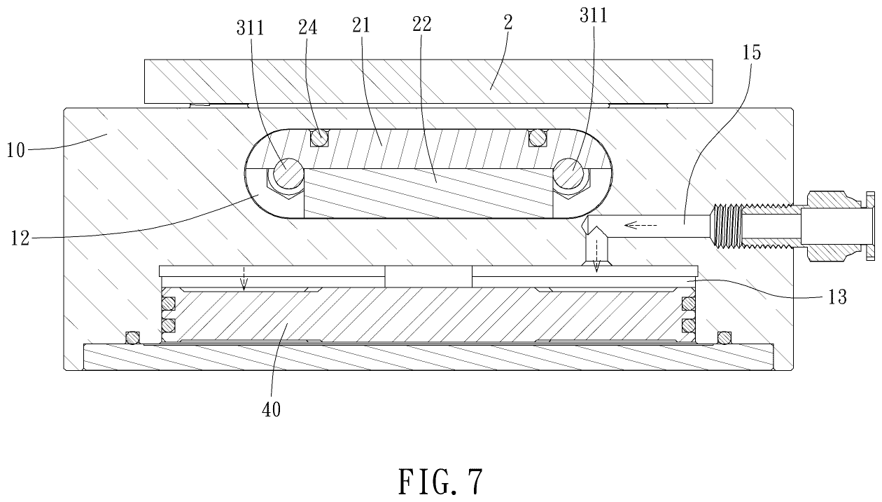

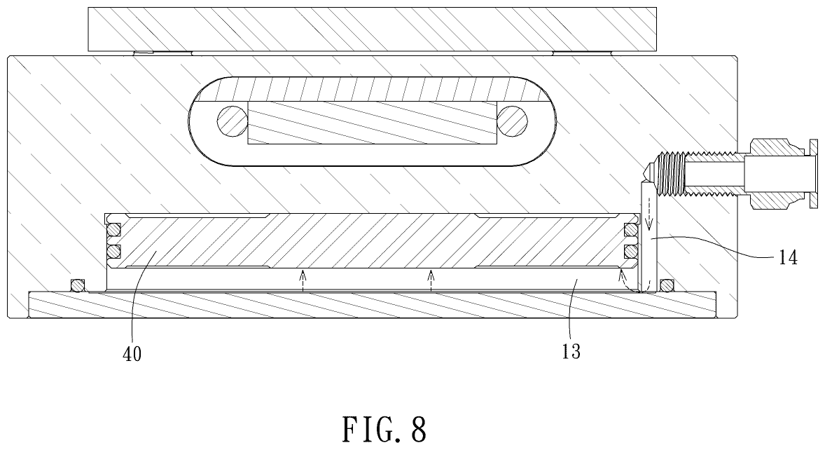

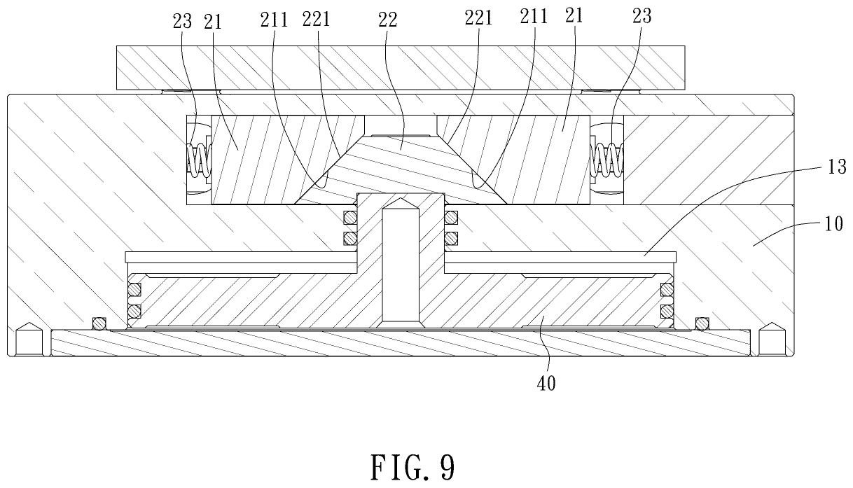

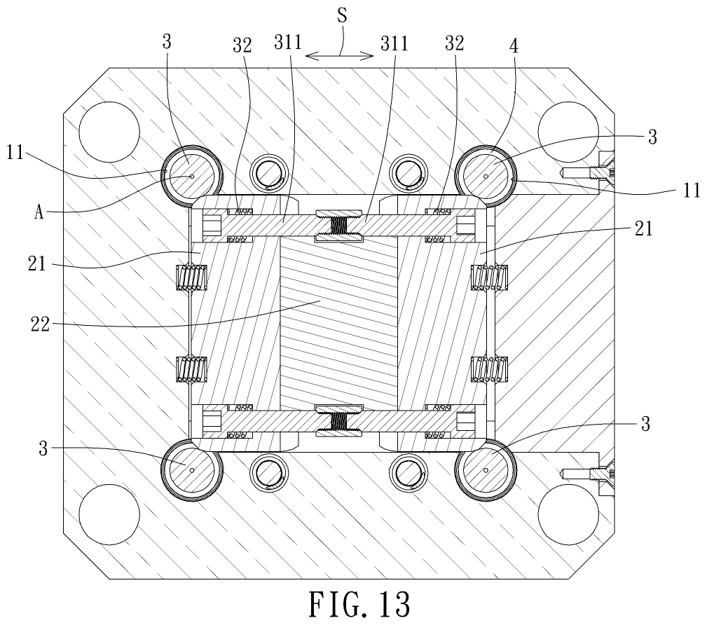

In operation, a fluid (e.g., gas or liquid) may optionally be introduced into the first flow channel 14 to push the piston 40 upward, thereby driving the push block 22 to move upward along the axial direction L1 (as shown in FIG. 8). The push block 22 then laterally pushes the plurality of clamping blocks 21 to move along an extending direction of the connector 31, away from each other, so as to engage within the plurality of positioning holes 11 and the plurality of recesses 4 of the plurality of positioning structures 3 (as shown in FIG. 13), while elastically compressing each of the at least one first elastic member 32, thereby achieving a positioning effect. Conversely, when the piston 40 drives the push block 22 to move downward to return to its original position (as shown in FIG. 7), each of the at least one first elastic member 32 elastically pushes the plurality of clamping blocks 21 to move along the extending direction of the connector 31 toward each other (as shown in FIG. 9), and the plurality of clamping blocks 21 are disengaged from the plurality of positioning holes 11 and the plurality of recesses 4 for releasing.

Therefore, the plurality of clamping blocks 21 are stably and smoothly moved toward or away from each other by a simple structure, without easily tilting or deviating, so as to quickly position or release the object to be positioned 2.

Specifically, the connector 31 of each of the at least one restoring assembly 30 includes two threaded members 311 (such as bolts or screws with head) and a nut 312, each of the two threaded members 311 s penetrates through one of the plurality of clamping blocks 21, the nut 312 is screwed with the two threaded members 311, and each of the plurality of clamping blocks 21 is movable relative to one of the two threaded members 311. Preferably, each of the at least one restoring assembly 30 includes a plurality of said first elastic members 32, and each of the plurality of said first elastic members 32 is elastically abutted against and between one of said threaded members 311 and one of the plurality of clamping blocks 21. Therefore, said threaded members 311 guide the plurality of clamping blocks 21 to stably move relative to each other.

Moreover, the nut 312 includes a first internal threaded section and a second internal threaded section which have opposite threading directions, one of the two threaded members 311 of each said connector 31 is screwed to the first internal threaded section, the other of the two threaded members 311 is screwed to the second internal threaded section. The nut 312 is rotatable in a forward or reverse direction to cause the two threaded members 311 to move toward or away from each other, thereby adjusting the relative positions among the plurality of clamping blocks 21 and improving positioning accuracy.

Preferably, the push block 22 has at least one engaging groove 222 recessed thereon, the nut 312 is engaged within the at least one engaging groove 222, and the nut 312 is abuttable against two side walls located at opposite sides of the at least one engaging groove 222 in the sliding direction S. In this embodiment, the clamping assembly 20 includes two said restoring assemblies 30, two opposite sides of the push block 22 have two said engaging groove 222 disposed thereon, and each said nut 312 is received within one of the two said engaging grooves 222. Each of the two threaded members 311 penetrates through one of the plurality of clamping blocks 21 in the sliding direction S. In this way, each said nut 312 is restricted within one of the two said engaging grooves 222 and prevented from moving relative to the push block 22 in the sliding direction S, thereby fixing relative positions of the two threaded members 311.

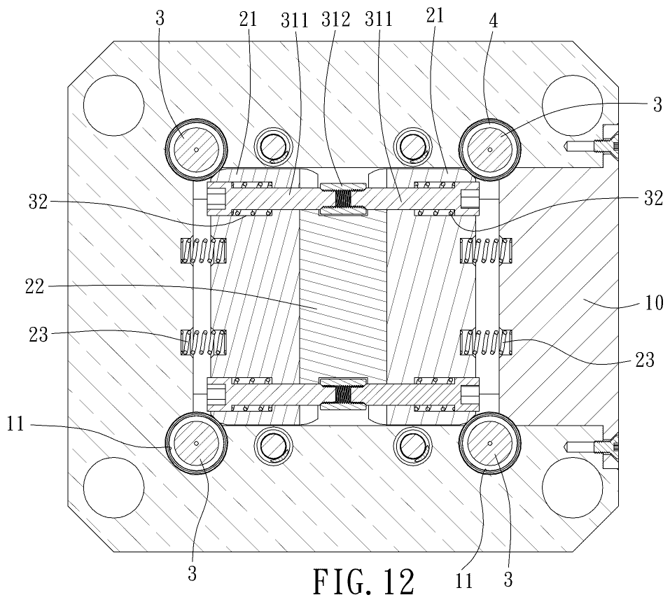

Preferably, the clamping assembly 20 further includes a plurality of second elastic members 23, and the plurality of second elastic members 23 are elastically abutted against and between the plurality of clamping blocks 21 and the base 1. The plurality of second elastic members 23 are parallel to the plurality of said first elastic members 32 of each of the two said restoring assemblies 30, so as to enhance an elastic force for returning the plurality of clamping blocks 21, as shown in FIGS. 12 and 13.

A surface of each of the plurality of clamping blocks 21 has at least one ball element 24 (preferably a plurality of ball elements 24), and the at least one ball element 24 contacts with an inner wall of the base 10, thereby allowing each of the plurality of clamping blocks 21 to slide stably and smoothly relative to the base 10.

The positioning device 1 further includes a plurality of pushing mechanisms 50. Each of the plurality of positioning holes 11 defines a central axis A, the central axis A extends along an the axial direction L1, and each of the plurality of positioning holes 11 is open in the axial direction L1. The base 10 further includes a second flow channel 15 and a plurality of receiving holes 16, the second flow channel 15 is communicated with the plurality of receiving holes 16 and the second receiving groove 13, and the plurality of pushing mechanisms 50 are disposed within the plurality of receiving holes 16. Each of the plurality of pushing mechanisms 50 is movable relative to one of the plurality of receiving holes 16 in the axial direction L1 to protrude beyond an outer surface of the base 10. Therefore, fluid can be introduced into the first flow channel 14 and the second flow channel 15 by a driving unit such as a pneumatic cylinder.

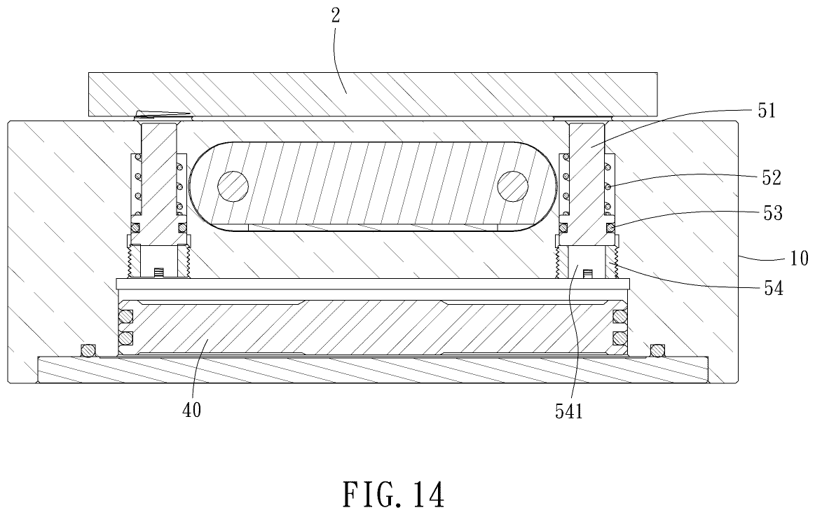

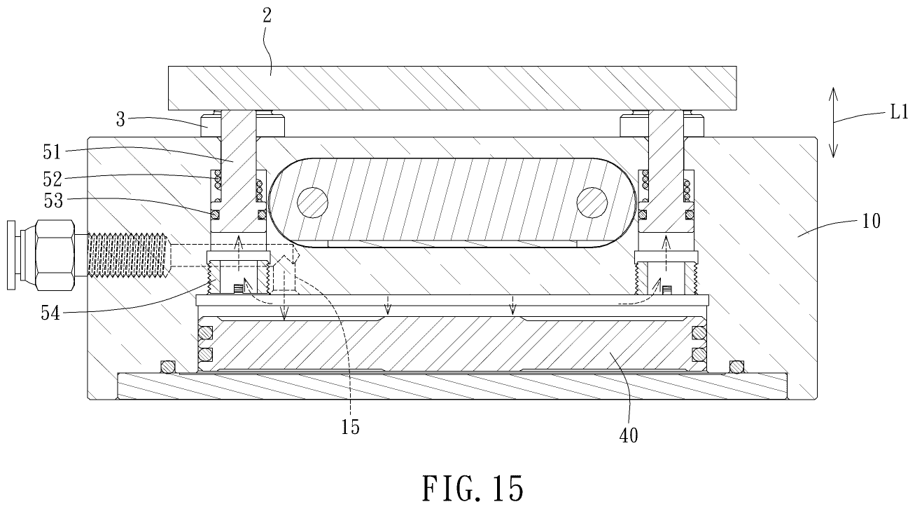

Specifically, each of the plurality of pushing mechanisms 50 includes a pushing member 51, a third elastic member 52 and a sealing ring 53, and the pushing member 51 is movable relative to one of the plurality of receiving holes 16 between a first position and a second position. When the pushing member 51 of at least one of the plurality of pushing mechanisms 50 is in the first position (as shown in FIG. 14), the pushing member 51 is located in one of the plurality of receiving holes 16. When the pushing member 51 of at least one of the plurality of pushing mechanisms 50 is in the second position (as shown in FIG. 15), the pushing member 51 protrudes beyond the outer surface of the base 10. The third elastic member 52 of each of the plurality of pushing mechanisms 50 is elastically abutted against and between the pushing member 51 and an inner wall defining one of the plurality of receiving holes 16, and the sealing ring 53 is disposed on the pushing member 51 and annularly abutted against the inner wall defining said receiving hole 16. Each of the plurality of receiving holes 16 has a positioning ring 54 disposed therewithin, and the positioning ring 54 is arranged to restrict the pushing member 51 from moving toward the second receiving groove 13. The positioning ring 54 of each of the plurality of receiving holes 16 has a through hole 541, and the through hole 541 communicates the second receiving groove 13 with the receiving holes 16. In this embodiment, the positioning ring 54 is screwed within one of the plurality of receiving holes 16 for easy assembling, disassembling and replacement.

The piston 40 is blockably positioned between the first flow channel 14 and the second flow channel 15. Each of the plurality of receiving holes 16 and each of the plurality of positioning holes 11 are open in the axial direction L1. By introducing fluid (gas or liquid) into the second flow channel 15, each said pushing member 51 is simultaneously pushed upward (moving from the first position to the second position), and the piston 40 is pressed downward. This movement simultaneously releases the plurality of clamping blocks 21 from engagement with the plurality of positioning structures 3 (as shown in the movement from FIG. 13 to FIG. 12) and pushes the plurality of positioning structures 3 of the object to be positioned 2 away from the plurality of positioning holes 11. Therefore, the plurality of positioning structures 3 are quickly and smoothly disengaged. Furthermore, when the fluid pressure is released, each said pushing member 51 can be moved by one said third elastic member 52 and returned to the first position.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A positioning device, including:
a base, includes a plurality of positioning holes, a first receiving groove, a second receiving groove and a first flow channel, the first flow channel communicated with the second receiving groove;
a clamping assembly, disposed within the first receiving groove, including a plurality of clamping blocks, a push block and at least one restoring assembly, the push block being movable to laterally push the plurality of clamping blocks to be engaged within the plurality of positioning holes, each of the plurality of clamping blocks having a first inclined surface, lateral sides of the push block having a plurality of second inclined surfaces, each of the plurality of second inclined surfaces being movably abutted against the first inclined surface of one of the plurality of clamping blocks, each of the at least one restoring assembly including a connector and at least one first elastic member, the connector disposed through the plurality of clamping blocks, the at least one first elastic member elastically abutted against and between one of the plurality of clamping blocks and the connector; and
a piston, movably disposed within the second receiving groove and annularly abutted against an inner periphery wall defining the second receiving groove, the push block being drivable by the piston to move relative to the plurality of clamping blocks.

2. The positioning device of claim 1, wherein the connector of each of the at least one restoring assembly includes two threaded members and a nut, each of the two threaded members penetrates through one of the plurality of clamping blocks, the nut is screwed with the two threaded members, and each of the plurality of clamping blocks is movable relative to one of the two threaded members.

3. The positioning device of claim 2, wherein each of the at least one restoring assembly includes a plurality of said first elastic members, each of the plurality of said first elastic members is elastically abutted against and between one of said threaded members and one of the plurality of clamping blocks.

4. The positioning device of claim 3, wherein the push block has at least one engaging groove recessed thereon, the nut is engaged within the at least one engaging groove, and the nut is abuttable against two side walls located at opposite sides of the at least one engaging groove in a sliding direction of each of the plurality of clamping blocks.

5. The positioning device of claim 1, wherein the clamping assembly further includes a plurality of second elastic members, the plurality of second elastic members are elastically abutted against and between the plurality of clamping blocks and the base and are parallel to the at least one first elastic member of each of the at least one restoring assembly.

6. The positioning device of claim 1, wherein a surface of each of the plurality of clamping blocks has at least one ball element disposed thereon, and the at least one ball element contacts with an inner wall of the base.

7. The positioning device of claim 1, wherein each of the plurality of positioning holes extends along an axial direction, the axial direction is lateral to a sliding direction of each of the plurality of clamping blocks, the plurality of positioning holes are configured for a plurality of positioning structures of an object to be positioned to be detachably received therewithin, and the plurality of clamping blocks are configured to be engaged within or disengaged from recesses of the plurality of positioning structures.

8. The positioning device of claim 1, further including a plurality of pushing mechanisms, wherein each of the plurality of positioning holes defines a central axis, the central axis extends along an axial direction, the base further includes a second flow channel and a plurality of receiving holes, the second flow channel is communicated with the plurality of receiving holes and the second receiving groove, the plurality of pushing mechanisms are disposed within the plurality of receiving holes, and each of the plurality of pushing mechanisms is movable relative to one of the plurality of receiving holes in the axial direction to protrude beyond an outer surface of the base.

9. The positioning device of claim 8, wherein the second flow channel is communicated with the second receiving groove, and the piston is blockably positioned between the first flow channel and the second flow channel.

10. The positioning device of claim 4, wherein the clamping assembly includes two said restoring assemblies, two opposite sides of the push block have two said engaging grooves disposed thereon, each said nut is received within one of the two said engaging grooves; each of the two threaded members penetrates through one of the plurality of clamping blocks in the sliding direction; the clamping assembly further includes a plurality of second elastic members, the plurality of second elastic members are elastically abutted against and between the plurality of clamping blocks and the base and are parallel to the plurality of said first elastic members of each of the two said restoring assemblies; a surface of each of the plurality of clamping blocks has at least one ball element disposed thereon, and the at least one ball element contacts with an inner wall of the base; each of the plurality of positioning holes extends along an axial direction, the axial direction is lateral to the sliding direction of each of the plurality of clamping blocks, the plurality of positioning holes are configured for a plurality of positioning structures of an object to be positioned to be detachably received therewithin, the plurality of clamping blocks are configured to be engaged within or disengaged from recesses of the plurality of positioning structures; the positioning device further includes a plurality of pushing mechanisms, each of the plurality of positioning holes defines a central axis, the central axis extends along the axial direction, each of the plurality of positioning holes is open in the axial direction, the base further includes a second flow channel and a plurality of receiving holes, the second flow channel is communicated with the plurality of receiving holes, the plurality of pushing mechanisms are disposed within the plurality of receiving holes, and each of the plurality of pushing mechanisms is movable relative to one of the plurality of receiving holes in the axial direction to protrude beyond an outer surface of the base; the second flow channel is communicated with the second receiving groove, the piston is blockably positioned between the first flow channel and the second flow channel; each of the plurality of pushing mechanisms includes a pushing member, a third elastic member and a sealing ring, the pushing member is movable relative to one of the plurality of receiving holes between a first position and a second position, when the pushing member is in the first position, the pushing member is located in one of the plurality of receiving holes, when the pushing member is located in the second position, the pushing member protrudes beyond the outer surface of the base; the third elastic member of each of the plurality of pushing mechanisms is elastically abutted against and between the pushing member and an inner wall defining one of the plurality of receiving holes, and the sealing ring is disposed on the pushing member and annularly abutted against the inner wall; each of the plurality of receiving holes has a positioning ring disposed therewithin, the positioning ring is arranged to restrict the pushing member from moving toward the second receiving groove, the positioning ring has a through hole, the through hole communicates the second receiving groove with one of the plurality of receiving holes.
